(19) United States
(12) Patent Application Publication
(10) Pub. No.: US 2020/0176899 A1
(43) Pub. Date: Jun. 4, 2020

(54) Connector Producing A Biasing Force

(71) Applicant: PPC BROADBAND, INC., East Syracuse, NY (US)

(72) Inventors: Trevor Ehret, North Haven, CT (US); Richard A. Haube, Cazenovia, NY (US); Noah P. Montena, Syracuse, NY (US); Souheil Zraik, Liverpool, NY (US)

(73) Assignee: PPC BROADBAND, INC., East Syracuse, NY (US)

(21) Appl. No.: 16/788,008

(22) Filed: Feb. 11, 2020

Related U.S. Application Data
(63) Continuation of application No. 16/254,317, filed on Jan. 22, 2019, now Pat. No. 10,559,898.
Application No. 16/254,317 is a continuation of application No. 15/601,455, filed on May 22, 2017, now Pat. No. 10,186,790.
Application No. 15/601,455 is a continuation of application No. 14/173,462, filed on Feb. 5, 2014, now Pat. No. 9,660,360.
Application No. 14/173,462 is a continuation of application No. 13/913,043, filed on Jun. 7, 2013, now Pat. No. 9,608,345.
Application No. 13/913,043 is a continuation of application No. 13/726,330, filed on Dec. 24, 2012, now Pat. No. 8,480,430.
Application No. 13/726,330 is a continuation of application No. 13/075,406, filed on Mar. 30, 2011, now Pat. No. 8,366,481.

(51) Int. Cl. H01R 9/05; H01R 13/502; H01R 13/62; H01R 4/48; H01R 43/26; H01R 43/16; H01R 43/00

(52) U.S. Cl. CPC H01R 9/0521; H01R 13/5025; H01R 13/62; H01R 4/48; H01R 13/622; H01R 43/16; H01R 43/00; H01R 9/0527; H01R 9/05; H01R 43/26

(57) ABSTRACT

A connector includes, in one embodiment, a first component, a coupling element configured to engage the first component, and a second component configured to engage the first component. The second component, in one embodiment, is configured to produce a spring, pushing or biasing force.

### CROSS REFERENCE TO RELATED APPLICATIONS

This is a continuation of U.S. patent application Ser. No. 16/254,317, filed Jan. 22, 2019, pending, which is a continuation of U.S. patent application Ser. No. 15/601,455, filed May 22, 2017, now U.S. Pat. No. 10,186,790, which is a continuation of U.S. patent application Ser. No. 14/173,462, filed on Feb. 5, 2014, now U.S. Pat. No. 9,660,360, which is a continuation of U.S. patent application Ser. No. 13/913,043, filed on Jun. 7, 2013, now U.S. Pat. No. 9,608,345, which is a continuation of U.S. patent application Ser. No. 13/726,330, filed on Dec. 24, 2012, now U.S. Pat. No. 8,480,430, which is a continuation of U.S. patent application Ser. No. 13/075,406, filed on Mar. 30, 2011, now U.S. Pat. No. 8,366,481.

This application is related to the following commonly-owned, co-pending patent applications: (a) U.S. patent application Ser. No. 13/712,470, filed on Dec. 12, 2012, now U.S. Pat. No. 8,920,192; (b) U.S. patent application Ser. No. 13/758,586, filed on Feb. 4, 2013 now U.S. Pat. No. 9,017,101; (c) U.S. patent application Ser. No. 13/971,147, filed on Aug. 20, 2013, now U.S. Pat. No. 8,801,448; (d) U.S. patent application Ser. No. 14/092,103, filed on Nov. 27, 2013 now U.S. Pat. No. 8,920,182; (e) U.S. patent application Ser. No. 14/092,003, filed on Nov. 27, 2013, now U.S. Pat. No. 8,915,754; (f) U.S. patent application Ser. No. 14/091,875, filed on Nov. 27, 2013, now U.S. Pat. No. 8,858,251; (g) U.S. patent application Ser. No. 14/134,892 filed on Dec. 19, 2013; (h) U.S. patent application Ser. No. 14/104,463, filed on Dec. 12, 2013, now U.S. Pat. No. 9,419,389; (i) U.S. patent application Ser. No. 14/104,363, filed on Dec. 12, 2013, now U.S. Pat. No. 9,511,457 and (j) U.S. patent application Ser. No. 14/173,355, filed on Feb. 5, 2014.

### FIELD OF TECHNOLOGY

The following relates to connectors used in coaxial cable communication applications, and more specifically to embodiments of a connector having a biasing member for maintaining continuity through a connector.

### BACKGROUND

Connectors for coaxial cables are typically connected onto complementary interface ports to electrically integrate coaxial cables to various electronic devices. Maintaining continuity through a coaxial cable connector typically involves the continuous contact of conductive connector components which can prevent radio frequency (RF) leakage and ensure a stable ground connection. In some instances, the coaxial cable connectors are present outdoors, exposed to weather and other numerous environmental elements. Weathering and various environmental elements can work to create interference problems when metallic conductive connector components corrode, rust, deteriorate or become galvanically incompatible, thereby resulting in intermittent contact, poor electromagnetic shielding, and degradation of the signal quality. Moreover, some metallic connector components can permanently deform under the torque requirements of the connector mating with an interface port. The permanent deformation of a metallic connector component results in intermittent contact between the conductive components of the connector and a loss of continuity through the connector.

Thus, a need exists for an apparatus and method for ensuring continuous contact between conductive components of a connector.

### SUMMARY

A first general aspect relates to a coaxial cable connector comprising a post having a first end, a second end, and a flange proximate the second end, wherein the post is configured to receive a center conductor surrounded by a dielectric of a coaxial cable, a connector body attached to the post, a coupling element attached to the post, the coupling element having a first end and a second end, and a biasing member disposed within a cavity formed between the first end of the coupling element and the connector body to bias the coupling element against the post.

A second general aspect relates to a coaxial cable connector comprising a post having a first end, a second end, and a flange proximate the second end, wherein the post is configured to receive a center conductor surrounded by a dielectric of a coaxial cable, a coupling element attached to the post, the coupling element having a first end and a second end, and a connector body having a biasing element, wherein the biasing element biases the coupling element against the post.

A third general aspect relates to a coaxial cable connector comprising a post having a first end, a second end, and a flange proximate the second end, wherein the post is configured to receive a center conductor surrounded by a dielectric of a coaxial cable, a connector body attached to the post, a coupling element attached to the post, the coupling element having a first end and a second end, and a means for biasing the coupling element against the post, wherein the means does not hinder rotational movement of the coupling element.

A fourth general aspect relates to a method of facilitating continuity through a coaxial cable connector, comprising providing a post having a first end, a second end, and a flange proximate the second end, wherein the post is configured to receive a center conductor surrounded by a dielectric of a coaxial cable, a connector body attached to the post, and a coupling element attached to the post, the coupling element having a first end and a second end, and disposing a biasing member within a cavity formed between the first end of the coupling element and the connector body to bias the coupling element against the post.

A fifth general aspect relates to a method of facilitating continuity through a coaxial cable connector, comprising providing a post having a first end, a second end, and a flange proximate the second end, wherein the post is configured to receive a center conductor surrounded by a dielectric of a coaxial cable, a coupling element attached to the post, the coupling element having a first end and a second end, and a connector body having a first end, a second end, and an annular recess proximate the second end of the connector body, extending the annular recess a radial distance to engage the coupling element, wherein the engagement between the extended annular recess and the coupling element biases the coupling element against the post.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1A depicts a cross-sectional view of a first embodiment of a coaxial cable connector;

FIG. 1B depicts a perspective cut-away view of the first embodiment of a coaxial cable connector;

FIG. 2 depicts a perspective view of an embodiment of a coaxial cable;

FIG. 3 depicts a cross-sectional view of an embodiment of a post;

FIG. 4 depicts a cross-sectional view of an embodiment of a coupling element;

FIG. 5 depicts a cross-sectional view of a first embodiment of a connector body;

FIG. 6 depicts a cross-sectional view of an embodiment of a fastener member;

FIG. 7 depicts a cross-sectional view of a second embodiment of a coaxial cable connector;

FIG. 8A depicts a cross-sectional view of a third embodiment of a coaxial cable connector;

FIG. 8B depicts a perspective cut-away of the third embodiment of a coaxial cable connector;

FIG. 9 depicts a cross-sectional view of a second embodiment of a connector body;

FIG. 10A depicts a cross-sectional view of the connector shown in FIG. 8A, with the connector fully tightened onto an interface port; and

FIG. 10B depicts a cross-sectional view of the connector shown in FIG. 10A, except the connector is not fully tightened onto the interface port.

### DETAILED DESCRIPTION OF EMBODIMENTS

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

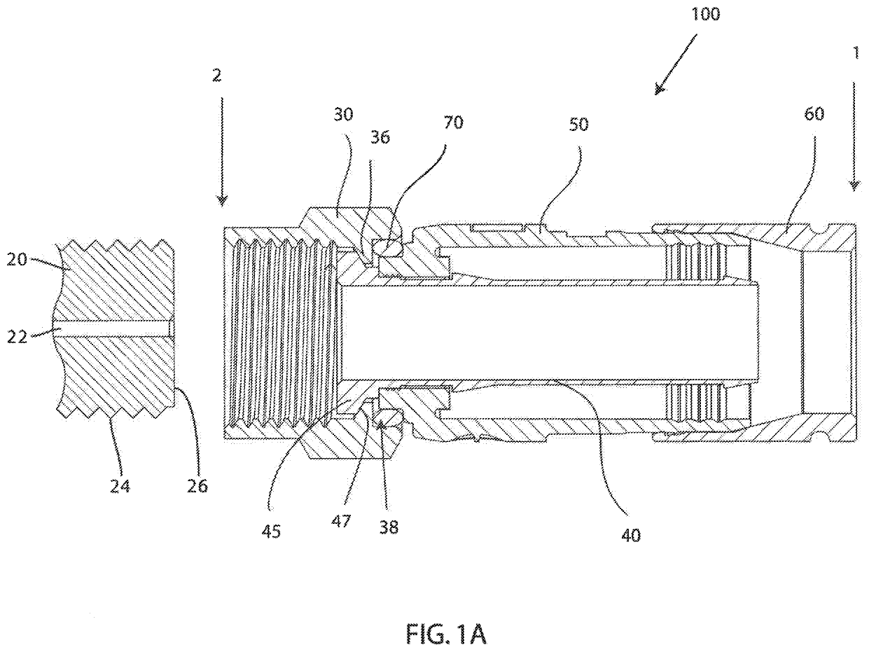

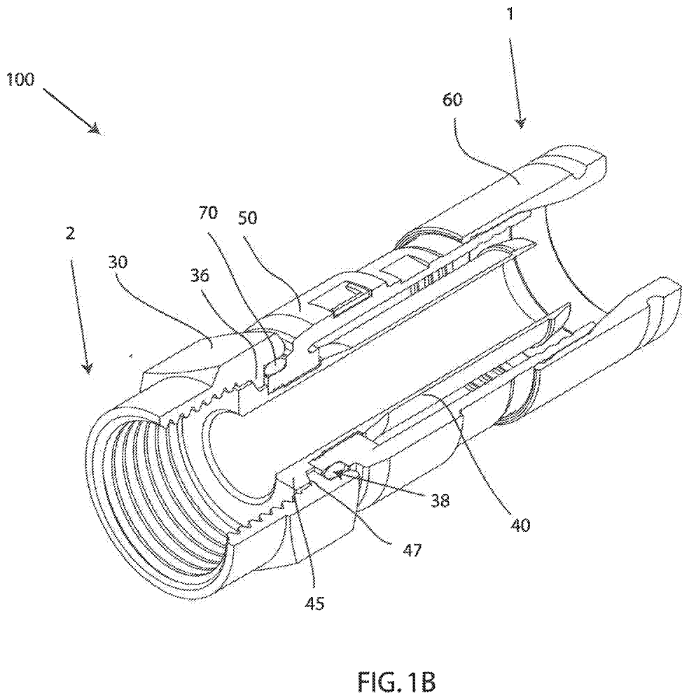

Referring to the drawings, FIG. 1 depicts an embodiment of a coaxial cable connector 100. A coaxial cable connector embodiment 100 has a first end 1 and a second end 2, and can be provided to a user in a preassembled configuration to ease handling and installation during use. Coaxial cable connector 100 may be an F connector, or similar coaxial cable connector. Furthermore, the connector 100 includes a post 40 configured for receiving a prepared portion of a coaxial cable 10.

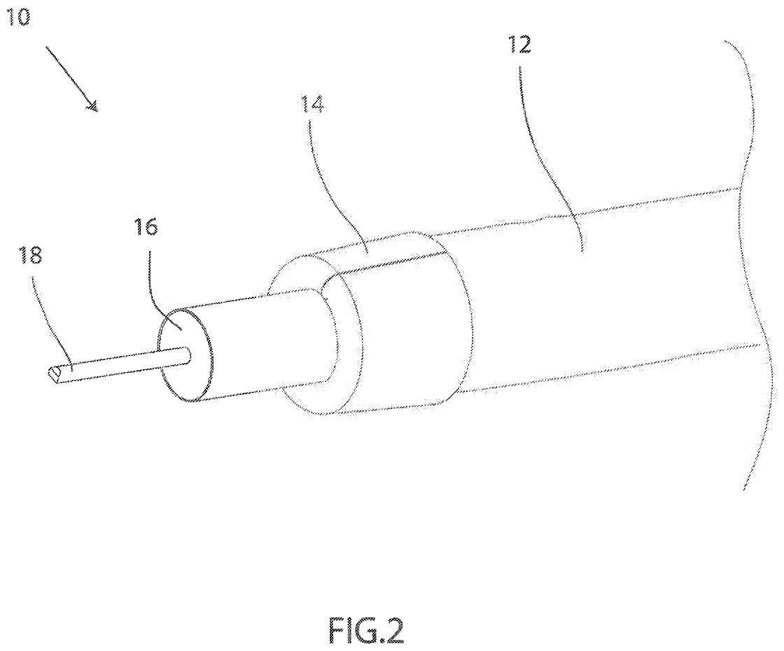

Referring now to FIG. 2, the coaxial cable connector 100 may be operably affixed to a prepared end of a coaxial cable 10 so that the cable 10 is securely attached to the connector 100. The coaxial cable 10 may include a center conductive strand 18, surrounded by an interior dielectric 16; the interior dielectric 16 may possibly be surrounded by a conductive foil layer; the interior dielectric 16 (and the possible conductive foil layer) is surrounded by a conductive strand layer 14; the conductive strand layer 14 is surrounded by a protective outer jacket 12a, wherein the protective outer jacket 12 has dielectric properties and serves as an insulator. The conductive strand layer 14 may extend a grounding path providing an electromagnetic shield about the center conductive strand 18 of the coaxial cable 10. The coaxial cable 10 may be prepared by removing the protective outer jacket 12 and drawing back the conductive strand layer 14 to expose a portion of the interior dielectric 16 (and possibly the conductive foil layer that may tightly surround the interior dielectric 16) and center conductive strand 18. The protective outer jacket 12 can physically protect the various components of the coaxial cable 10 from damage which may result from exposure to dirt or moisture, and from corrosion. Moreover, the protective outer jacket 12 may serve in some measure to secure the various components of the coaxial cable 10 in a contained cable design that protects the cable 10 from damage related to movement during cable installation. However, when the protective outer jacket 12 is exposed to the environment, rain and other environmental pollutants may travel down the protective outer jack 12. The conductive strand layer 14 can be comprised of conductive materials suitable for carrying electromagnetic signals and/or providing an electrical ground connection or electrical path connection. The conductive strand layer 14 may also be a conductive layer, braided layer, and the like. Various embodiments of the conductive strand layer 14 may be employed to screen unwanted noise. For instance, the conductive strand layer 14 may comprise a metal foil (in addition to the possible conductive foil) wrapped around the dielectric 16 and/or several conductive strands formed in a continuous braid around the dielectric 16. Combinations of foil and/or braided strands may be utilized wherein the conductive strand layer 14 may comprise a foil layer, then a braided layer, and then a foil layer. Those in the art will appreciate that various layer combinations may be implemented in order for the conductive strand layer 14 to effectuate an electromagnetic buffer helping to prevent ingress of environmental noise or unwanted noise that may disrupt broadband communications. In some embodiments, there may be flooding compounds protecting the conductive strand layer 14. The dielectric 16 may be comprised of materials suitable for electrical insulation. The protective outer jacket 12 may also be comprised of materials suitable for electrical insulation. It should be noted that the various materials of which all the various components of the coaxial cable 10 should have some degree of elasticity allowing the cable 10 to flex or bend in accordance with traditional broadband communications standards, installation methods and/or equipment. It should further be recognized that the radial thickness of the coaxial cable 10, protective outer jacket 12, conductive strand layer 14, possible conductive foil layer, interior dielectric 16 and/or center conductive strand 18 may vary based upon generally recognized parameters corresponding to broadband communication standards and/or equipment.

Furthermore, environmental elements that contact conductive components, including metallic components, of a coaxial connector may be important to the longevity and efficiency of the coaxial cable connector (i.e. preventing RF leakage and ensuring stable continuity through the connector 100). Environmental elements may include any environmental pollutant, any contaminant, chemical compound, rainwater, moisture, condensation, stormwater, polychlorinated biphenyl's (PCBs), contaminated soil from runoff, pesticides, herbicides, and the like. Environmental elements, such as water or moisture, may corrode, rust, degrade, etc. connector components exposed to the environmental elements. Thus, metallic conductive O-rings utilized by a coaxial cable connector that may be disposed in a position of exposure to environmental elements may be insufficient over time due to the corrosion, rusting, and overall degradation of the metallic O-ring.

Referring back to FIG. 1, the connector 100 may mate with a coaxial cable interface port 20. The coaxial cable interface port 20 includes a conductive receptacle 22 for receiving a portion of a coaxial cable center conductor 18 sufficient to make adequate electrical contact. The coaxial cable interface port 20 may further comprise a threaded exterior surface 24. However, various embodiments may employ a smooth surface, as opposed to threaded exterior surface. In addition, the coaxial cable interface port 20 may comprise a mating edge 26. It should be recognized that the radial thickness and/or the length of the coaxial cable interface port 20 and/or the conductive receptacle 22 may vary based upon generally recognized parameters corresponding to broadband communication standards and/or equipment. Moreover, the pitch and depth of threads which may be formed upon the threaded exterior surface 24 of the coaxial cable interface port 20 may also vary based upon generally recognized parameters corresponding to broadband communication standards and/or equipment. Furthermore, it should be noted that the interface port 20 may be formed of a single conductive material, multiple conductive materials, or may be configured with both conductive and non-conductive materials corresponding to the port's 20 electrical interface with a coaxial cable connector, such as connector 100. For example, the threaded exterior surface may be fabricated from a conductive material, while the material comprising the mating edge 26 may be non-conductive or vice versa. However, the conductive receptacle 22 should be formed of a conductive material. Further still, it will be understood by those of ordinary skill that the interface port 20 may be embodied by a connective interface component of a communications modifying device such as a signal splitter, a cable line extender, a cable network module and/or the like.

Referring further to FIG. 1, embodiments of a connector 100 may include a post 40, a coupling element 30, a connector body 50, a fastener member 60, and a biasing member 70. Embodiments of connector 100 may also include a post 40 having a first end 41, a second end 42, and a flange 45 proximate the second end 42, wherein the post 40 is configured to receive a center conductor 18 surrounded by a dielectric 16 of a coaxial cable 10, a connector body 50 attached to the post 40, a coupling element 30 attached to the post 40, the coupling element 30 having a first end 31 and a second end 32, and a biasing member 70 disposed within a cavity 38 formed between the first end 31 of the coupling element 30 and the connector body 50 to bias the coupling element 30 against the post 40.

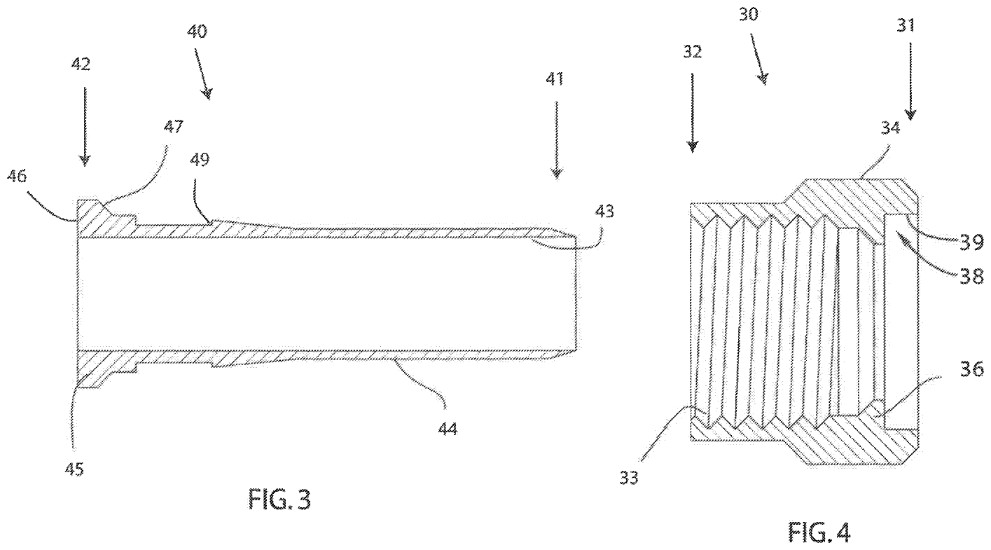

Embodiments of connector 100 may include a post 40, as further shown in FIG. 3. The post 40 comprises a first end 41, a second end 42, an inner surface 43, and an outer surface 44. Furthermore, the post 40 may include a flange 45, such as an externally extending annular protrusion, located proximate or otherwise near the second end 42 of the post 40. The flange 45 may include an outer tapered surface 47 facing the first end 41 of the post 40 (i.e. tapers inward toward the first end 41 from a larger outer diameter proximate or otherwise near the second end 42 to a smaller outer diameter. The outer tapered surface 47 of the flange 45 may correspond to a tapered surface of the lip 36 of the coupling element 30. Further still, an embodiment of the post 40 may include a surface feature 49 such as a lip or protrusion that may engage a portion of a connector body 50 to secure axial movement of the post 40 relative to the connector body 50. However, the post may not include such a surface feature 49, and the coaxial cable connector 100 may rely on press-fitting and friction-fitting forces and/or other component structures to help retain the post 40 in secure location both axially and rotationally relative to the connector body 50. The location proximate or otherwise near where the connector body 50 is secured relative to the post 40 may include surface features, such as ridges, grooves, protrusions, or knurling, which may enhance the secure location of the post 40 with respect to the connector body 50. Additionally, the post 40 includes a mating edge 46, which may be configured to make physical and electrical contact with a corresponding mating edge 26 of an interface port 20. The post 40 should be formed such that portions of a prepared coaxial cable 10 including the dielectric 16 and center conductor 18 can pass axially into the first end 41 and/or through a portion of the tube-like body of the post 40. Moreover, the post 40 should be dimensioned such that the post 40 may be inserted into an end of the prepared coaxial cable 10, around the dielectric 16 and under the protective outer jacket 12 and conductive grounding shield or strand 14. Accordingly, where an embodiment of the post 40 may be inserted into an end of the prepared coaxial cable 10 under the drawn back conductive strand 14, substantial physical and/or electrical contact with the strand layer 14 may be accomplished thereby facilitating grounding through the post 40. The post 40 may be formed of metals or other conductive materials that would facilitate a rigidly formed post body. In addition, the post 40 may be formed of a combination of both conductive and non-conductive materials. For example, a metal coating or layer may be applied to a polymer of other non-conductive material. Manufacture of the post 40 may include casting, extruding, cutting, turning, drilling, knurling, injection molding, spraying, blow molding, component overmolding, or other fabrication methods that may provide efficient production of the component.

With continued reference to FIG. 1, and further reference to FIG. 4, embodiments of connector 100 may include a coupling element 30. The coupling element 30 may be a nut, a threaded nut, port coupling element, rotatable port coupling element, and the like. The coupling element 30 may include a first end 31, second end 32, an inner surface 33, and an outer surface 34. The inner surface 33 of the coupling element 30 may be a threaded configuration, the threads having a pitch and depth corresponding to a threaded port, such as interface port 20. In other embodiments, the inner surface 33 of the coupling element 30 may not include threads, and may be axially inserted over an interface port, such as port 20. The coupling element 30 may be rotatably secured to the post 40 to allow for rotational movement about the post 40. The coupling element 30 may comprise an internal lip 36 located proximate the first end 31 and configured to hinder axial movement of the post 40. Furthermore, the coupling element 30 may comprise a cavity 38 extending axially from the edge of first end 31 and partial defined and bounded by the internal lip 36. The cavity 38 may also be partially defined and bounded by an outer internal wall 39. The coupling element 30 may be formed of conductive materials facilitating grounding through the coupling element 30, or threaded nut. Accordingly the coupling element 30 may be configured to extend an electromagnetic buffer by electrically contacting conductive surfaces of an interface port 20 when a coaxial cable connector, such as connector 100, is advanced onto the port 20. In addition, the coupling element 30 may be formed of non-conductive material and function only to physically secure and advance a connector 100 onto an interface port 20. Moreover, the coupling element 30 may be formed of both conductive and non-conductive materials. For example the internal lip 36 may be formed of a polymer, while the remainder of the coupling element 30 may be comprised of a metal or other conductive material. In addition, the coupling element 30 may be formed of metals or polymers or other materials that would facilitate a rigidly formed body. Manufacture of the coupling element 30 may include casting, extruding, cutting, turning, tapping, drilling, injection molding, blow molding, or other fabrication methods that may provide efficient production of the component. Those in the art should appreciate the various of embodiments of the nut 30 may also comprise a coupler member, or coupling element, having no threads, but being dimensioned for operable connection to a corresponding interface port, such as interface port 20.

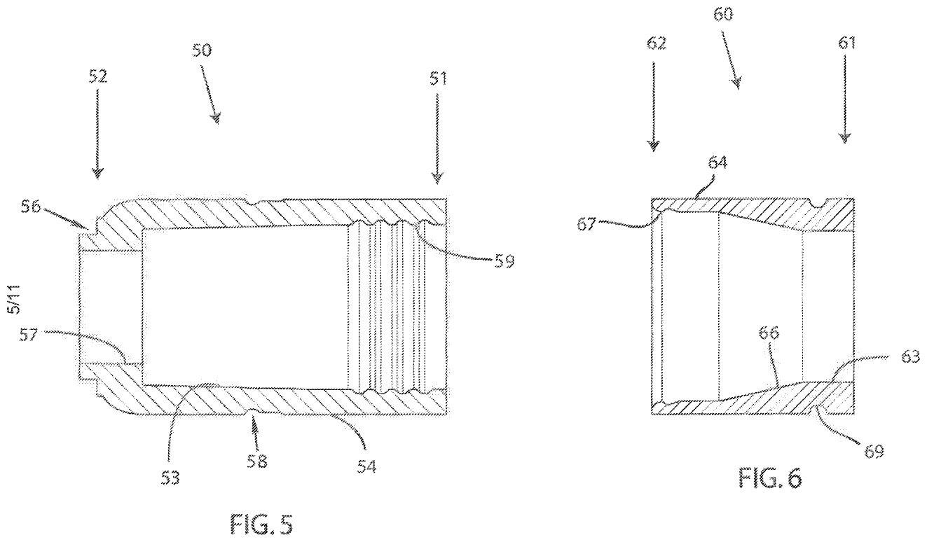

Referring still to FIG. 1, and additionally to FIG. 5, embodiments of a coaxial cable connector, such as connector 100, may include a connector body 50. The connector body 50 may include a first end 51, a second end 52, an inner surface 53, and an outer surface 54. Moreover, the connector body may include a post mounting portion 57 proximate or otherwise near the second end 52 of the body 50; the post mounting portion 57 configured to securely locate the body 50 relative to a portion of the outer surface 44 of post 40, so that the connector body 50 is axially secured with respect to the post 40, in a manner that prevents the two components from moving with respect to each other in a direction parallel to the axis of the connector 100. In addition, the connector body 50 may include an outer annular recess 56 located proximate or near the second end 52 of the connector body 50. Furthermore, the connector body 50 may include a semi-rigid, yet compliant outer surface 54, wherein the outer surface 54 may be configured to form an annular seal when the first end 51 is deformably compressed against a received coaxial cable 10 by operation of a fastener member 60. The connector body 50 may include an external annular detent 58 located along the outer surface 54 of the connector body 50. Further still, the connector body 50 may include internal surface features 59, such as annular serrations formed near or proximate the internal surface of the first end 51 of the connector body 50 and configured to enhance frictional restraint and gripping of an inserted and received coaxial cable 10, through tooth-like interaction with the cable. The connector body 50 may be formed of materials such as plastics, polymers, bendable metals or composite materials that facilitate a semi-rigid, yet compliant outer surface 54. Further, the connector body 50 may be formed of conductive or non-conductive materials or a combination thereof. Manufacture of the connector body 50 may include casting, extruding, cutting, turning, drilling, knurling, injection molding, spraying, blow molding, component overmolding, combinations thereof, or other fabrication methods that may provide efficient production of the component.

With further reference to FIG. 1 and FIG. 6, embodiments of a coaxial cable connector 100 may include a fastener member 60. The fastener member 60 may have a first end 61, second end 62, inner surface 63, and outer surface 64. In addition, the fastener member 60 may include an internal annular protrusion 67 located proximate the second end 62 of the fastener member 60 and configured to mate and achieve purchase with the annular detent 58 on the outer surface 54 of connector body 50. Moreover, the fastener member 60 may comprise a central passageway or generally axial opening defined between the first end 61 and second end 62 and extending axially through the fastener member 60. The central passageway may include a ramped surface 66 which may be positioned between a first opening or inner bore having a first inner diameter positioned proximate or otherwise near the first end 61 of the fastener member 60 and a second opening or inner bore having a larger, second inner diameter positioned proximate or otherwise near the second end 62 of the fastener member 60. The ramped surface 66 may act to deformably compress the outer surface 54 of the connector body 50 when the fastener member 60 is operated to secure a coaxial cable 10. For example, the narrowing geometry will compress squeeze against the cable, when the fastener member 60 is compressed into a tight and secured position on the connector body 50. Additionally, the fastener member 60 may comprise an exterior surface feature 69 positioned proximate with or close to the first end 61 of the fastener member 60. The surface feature 69 may facilitate gripping of the fastener member 60 during operation of the connector 100. Although the surface feature 69 is shown as an annular detent, it may have various shapes and sizes such as a ridge, notch, protrusion, knurling, or other friction or gripping type arrangements. The second end 62 of the fastener member 60 may extend an axial distance so that, when the fastener member 60 is compressed into sealing position on the coaxial cable 100, the fastener member 60 touches or resides substantially proximate significantly close to the coupling element 30. It should be recognized, by those skilled in the requisite art, that the fastener member 60 may be formed of rigid materials such as metals, hard plastics, polymers, composites and the like, and/or combinations thereof. Furthermore, the fastener member 60 may be manufactured via casting, extruding, cutting, turning, drilling, knurling, injection molding, spraying, blow molding, component overmolding, combinations thereof, or other fabrication methods that may provide efficient production of the component.

Referring back to FIG. 1, embodiments of a coaxial cable connector 100 can include a biasing member 70. The biasing member 70 may be formed of a non-metallic material to avoid rust, corrosion, deterioration, and the like, caused by environmental elements, such as water. Additional materials the biasing member 70 may be formed of may include, but are not limited to, polymers, plastics, elastomers, elastomeric mixtures, composite materials, rubber, and/or the like and/or any operable combination thereof. The biasing member 70 may be a resilient, rigid, semi-rigid, flexible, or elastic member, component, element, and the like. The resilient nature of the biasing member 70 may help avoid permanent deformation while under the torque requirements when a connector 100 is advanced onto an interface port 20.

Moreover, the biasing member 70 may facilitate constant contact between the coupling element 30 and the post 40. For instance, the biasing member 70 may bias, provide, force, ensure, deliver, etc. the contact between the coupling element 30 and the post 40. The constant contact between the coupling element 30 and the post 40 promotes continuity through the connector 100, reduces/eliminates RF leakage, and ensures a stable ground through the connection of a connector 100 to an interface port 20 in the event the connector 100 is not fully tightened onto the port 20. To establish and maintain solid, constant contact between the coupling element 30 and the post 40, the biasing member 70 may be disposed behind the coupling element 30, proximate or otherwise near the second end 52 of the connector. In other words, the biasing member 70 may be disposed within the cavity 38 formed between the coupling element 30 and the annular recess 56 of the connector body 50. The biasing member 70 can provide a biasing force against the coupling element 30, which may axially displace the coupling element 30 into constant direct contact with the post 40. In particular, the disposition of a biasing member 70 in annular cavity 38 proximate the second end 52 of the connector body 50 may axially displace the coupling element 30 towards the post 40, wherein the lip 36 of the coupling element 30 directly contacts the outer tapered surface 47 of the flange 45 of the post 40. The location and structure of the biasing member 70 may promote continuity between the post 40 and the coupling element 30, but does not impede the rotational movement of the coupling element 30 (e.g. rotational movement about the post 40). The biasing member 70 may also create a barrier against environmental elements, thereby preventing environmental elements from entering the connector 100. Those skilled in the art would appreciate that the biasing member 70 may be fabricated by extruding, coating, molding, injecting, cutting, turning, elastomeric batch processing, vulcanizing, mixing, stamping, casting, and/or the like and/or any combination thereof in order to provide efficient production of the component.

Embodiments of biasing member 70 may include an annular or semi-annular resilient member or component configured to physically and electrically couple the post 40 and the coupling element 30. One embodiment of the biasing member 70 may be a substantially circinate torus or toroid structure, or other ring-like structure having a diameter (or cross-section area) large enough that when disposed within annular cavity 38 proximate the annular recess 56 of the connector body 50, the coupling element 30 is axially displaced against the post 40 and/or biased against the post 40. Moreover, embodiments of the biasing member 70 may be an O-ring configured to cooperate with the annular recess 56 proximate the second end 52 of connector body 50 and the outer internal wall 39 and lip 36 forming cavity 38 such that the biasing member 70 may make contact with and/or bias against the annular recess 56 (or other portions) of connector body 50 and outer internal wall 39 and lip 36 of coupling element 30. The biasing between the outer internal wall 39 and lip 36 of the coupling element 30 and the annular recess 56, and surrounding portions, of the connector body 50 can drive and/or bias the coupling element 30 in a substantially axial or axial direction towards the second end 2 of the connector 100 to make solid and constant contact with the post 40. For instance, the biasing member 70 should be sized and dimensioned large enough (e.g. oversized O-ring) such that when disposed in cavity 38, the biasing member 70 exerts enough force against both the coupling element 30 and the connector body 50 to axial displace the coupling element 30 a distance towards the post 40. Thus, the biasing member 70 may facilitate grounding of the connector 100, and attached coaxial cable 10 (shown in FIG. 2), by extending the electrical connection between the post 40 and the coupling element 30. Because the biasing member 70 may not be metallic and/or conductive, it may resist degradation, rust, corrosion, etc., to environmental elements when the connector 100 is exposed to such environmental elements. Furthermore, the resiliency of the biasing member 70 may deform under torque requirements, as opposed to permanently deforming in a manner similar to metallic or rigid components under similar torque requirements. Axial displacement of the connector body 50 may also occur, but the surface 49 of the post 40 may prevent axial displacement of the connector body 50, or friction fitting between the connector body 50 and the post 40 may prevent axial displacement of the connector body 50.

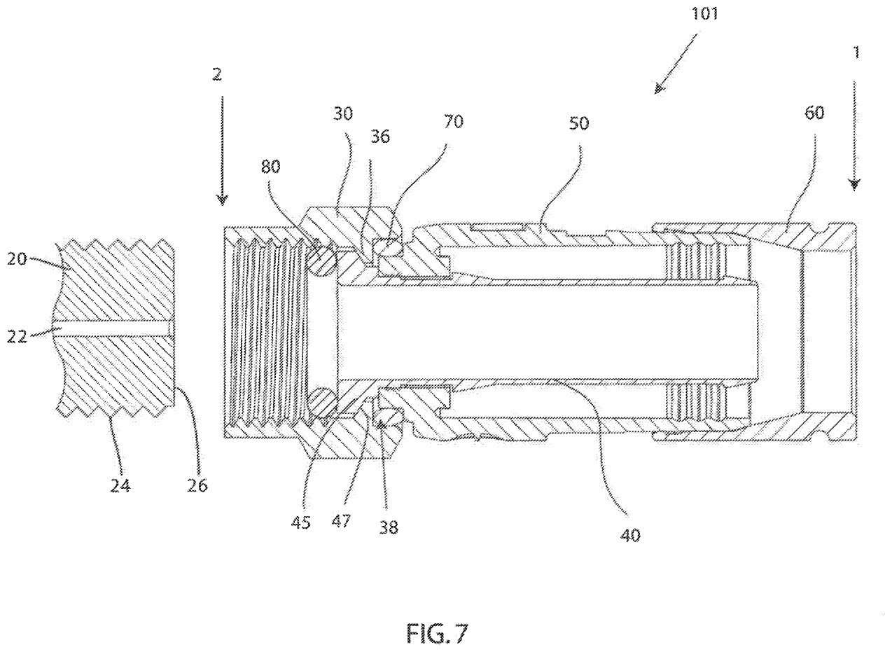

With continued reference to the drawings, FIG. 7 depicts an embodiment of connector 101. Connector 101 may include post 40, coupling element 30, connector body 50, fastener member 60, biasing member 70, but may also include a mating edge conductive member 80 formed of a conductive material. Such materials may include, but are not limited to conductive polymers, conductive plastics, conductive elastomers, conductive elastomeric mixtures, composite materials having conductive properties, soft metals, conductive rubber, and/or the like and/or any operable combination thereof. The mating edge conductive member 80 may comprise a substantially circinate torus or toroid structure, and may be disposed within the internal portion of coupling element 30 such that the mating edge conductive member 80 may make contact with and/or reside-continuou09s with a mating edge 46 of a post 40 when connector 101 is operably configured (e.g. assembled for communication with interface port 20). For example, one embodiment of the mating edge conductive member 80 may be an O-ring. The mating edge conductive member 80 may facilitate an annular seal between the coupling element 30 and post 40 thereby providing a physical barrier to unwanted ingress of moisture and/or other environmental contaminates. Moreover, the mating edge conductive member 80 may facilitate electrical coupling of the post 40 and coupling element 30 by extending therebetween an unbroken electrical circuit. In addition, the mating edge conductive member 80 may facilitate grounding of the connector 100, and attached coaxial cable (shown in FIG. 2), by extending the electrical connection between the post 40 and the coupling element 30. Furthermore, the mating edge conductive member 80 may effectuate a buffer preventing ingress of electromagnetic noise between the coupling element 30 and the post 40. The mating edge conductive member or O-ring 80 may be provided to users in an assembled position proximate the second end 42 of post 40, or users may themselves insert the mating edge conductive O-ring 80 into position prior to installation on an interface port 20. Those skilled in the art would appreciate that the mating edge conductive member 80 may be fabricated by extruding, coating, molding, injecting, cutting, turning, elastomeric batch processing, vulcanizing, mixing, stamping, casting, and/or the like and/or any combination thereof in order to provide efficient production of the component.

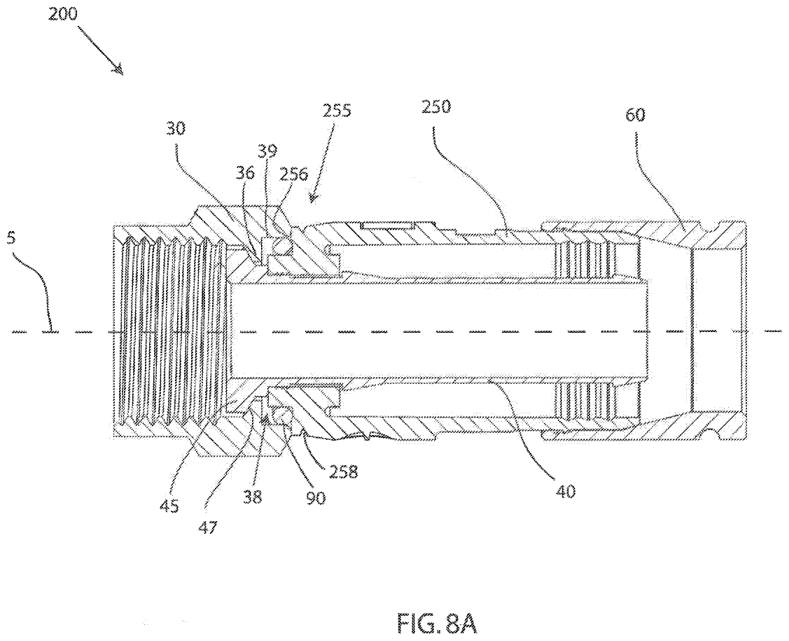

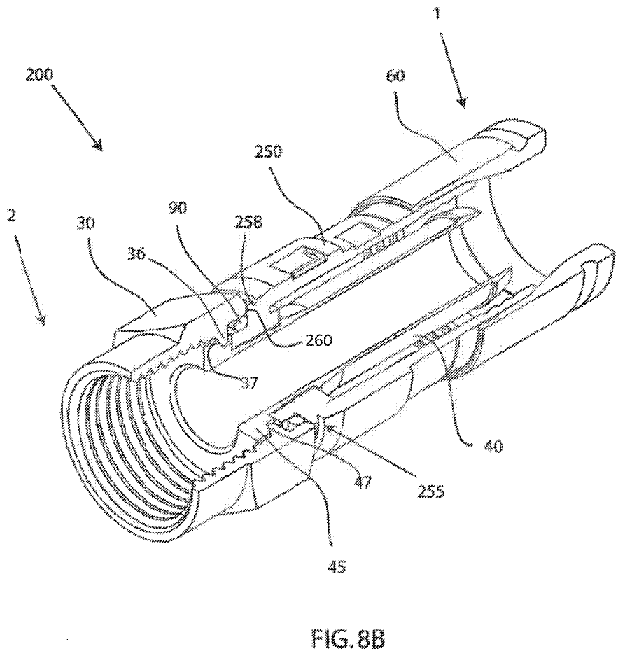

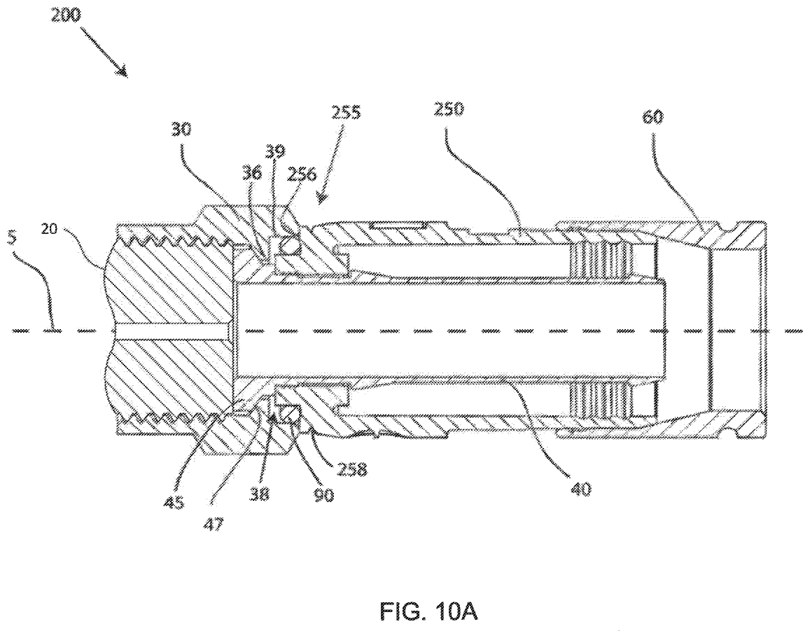

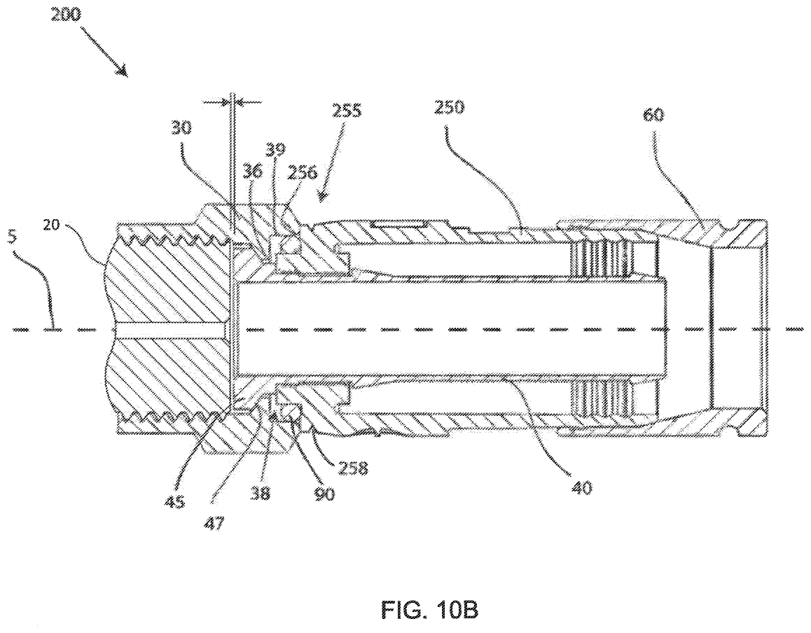

Referring now to FIGS. 8A, 8B, and 10A, an embodiment of connector 200 is described. Embodiments of connector 200 may include a post 40, a coupling element 30, a fastener member 60, a connector body 250 having biasing element 255, and a connector body member 90. Embodiments of the post 40, coupling element 30, and fastener member 60 described in association with connector 200 may share the same structural and functional aspects as described above in association with connectors 100, 101. Embodiments of connector 200 may also include a post 40 having a first end 41, a second end 42, and a flange 45 proximate the second end 42. Additionally, the post 40 includes a mating edge 46 (FIG. 3), which may be configured to make physical and electrical contact with a corresponding mating edge 26 (FIG. 7) of an interface port 20. The post 40 is configured to receive a center conductor surrounded 18 by a dielectric 16 of a coaxial cable 10, a coupling element 30 attached to the post 40, the coupling element 30 having a first end 31 and a second end 32, and a connector body 250 having biasing element 255, wherein the engagement biasing element 255 biases the coupling element 30 against the post 40.

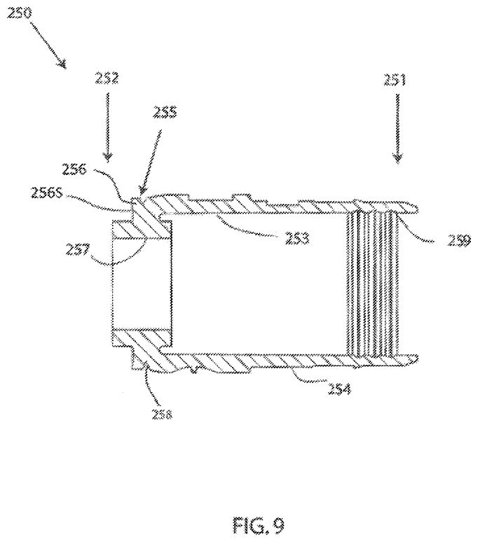

With reference now to FIG. 9, and continued reference to FIGS. 8A and 8B, embodiments of connector 200 may include a connector body 250 having a biasing element 255. The connector body 250 may include a first end 251, a second end 252, an inner surface 253, and an outer surface 254. Moreover, the connector body 250 may include a post mounting portion 257 proximate or otherwise near the second end 252 of the body 250; the post mounting portion 257 configured to securely locate the body 250 relative to a portion of the outer surface 44 of post 40, so that the connector body 250 is axially secured with respect to the post 40, in a manner that prevents the two components from moving with respect to each other in a direction parallel to the axis of the connector 200. In addition, the connector body 250 may include an extended, resilient integral biasing or grounding portion 256 defining an annular, forward facing body surface 256S located proximate or near the second end 252 of the connector body 250. The extended, resilient grounding portion 256 may extend a radial distance with respect to a general axis 5 of the connector 200 to facilitate biasing engagement with the coupler or port engaging portion 30. For instance, the extended biasing or grounding portion 256 may radially extend past the internal wall 39 of the coupler or port engaging portion 30. In one embodiment, the extended, resilient integral biasing or grounding portion 256 may be a resilient extension of annular recess 56 of connector body 50. In other embodiments, the extended, resilient integral biasing or grounding portion 256, or shoulder, may function as a biasing element 255 proximate the second end 252. The biasing element 255 may be structurally integral with the connector body 250, such that the biasing element 255 is a portion of the connector body 250. In other embodiments, the biasing element 255 may be a separate component fitted or configured to be coupled with (e.g. adhered, snapped on, interference fit, and the like) an existing connector body, such as connector body 50. Moreover, the biasing element 255 of connector body 250 may be defined as a portion of the connector body 255, proximate the second end 252, that extends radially and potentially axially (slightly) from the body to bias the coupler or port engaging portion 30, proximate the first end 31, into contact with the post 40. The biasing element 255 may include a notch 258 to permit the necessary deflection to provide a biasing force to effectuate constant physical contact between the lip 36 of the coupling element 30 and the outer tapered surface or rearward facing port surface 47 of the flange 45 of the post 40. The notch 258 may be a notch, groove, channel, or similar annular void that results in an annular portion of the connector body 50 that is removed to permit deflection in an axial direction with respect to the general axis 5 of connector 200.

Accordingly, a portion of the extended, resilient integral biasing or grounding portion 256, or the biasing element 255, may engage the coupling element 30 to bias the coupling element 30 into contact with the post 40. Contact between the coupling element 30 and the post 40 may promote continuity through the connector 200, reduce/eliminate RF leakage, and ensure a stable ground through the connection of the connector 200 to an interface port 20 in the event the connector 200 is not fully tightened onto the port 20, as shown in FIG. 10B. In most embodiments, the resilient integral biasing or grounding portion 256 of the biasing element 255 may provide a constant biasing force the coupling element 30. The biasing force provided by the resilient integral biasing or grounding portion 256, of biasing element 255, may result in constant contact between the lip 36 of the coupling element 30 and the rearward facing post surface 47 of the post 40. However, the biasing force of the resilient integral biasing or grounding portion 256, of biasing element 255, should not (significantly) hinder or prevent the rotational movement of the coupling element 30 (i.e. rotation of the coupling element 30 about the post 40). Because connector 200 may include a connector body 250 having an resilient integral biasing or grounding portion 256 to improve continuity, there may be no need for an additional component such as a metallic conductive continuity member that is subject to corrosion and permanent deformation during operable advancement and disengagement with an interface port 20, which may ultimately adversely affect the signal quality (e.g. corrosion or deformation of conductive member may degrade the signal quality).

Furthermore, the connector body 250 may include a semi-rigid, yet compliant outer surface 254, wherein the outer surface 254 may be configured to form an annular seal when the first end 251 is deformably compressed against a received coaxial cable 10 by operation of a fastener member 60. Further still, the connector body 250 may include internal surface features 259, such as annular serrations formed near or proximate the internal surface of the first end 251 of the connector body 250 and configured to enhance frictional restraint and gripping of an inserted and received coaxial cable 10, through tooth-like interaction with the cable. The connector body 250 may be formed of materials such as plastics, polymers, bendable metals or composite materials that facilitate a semi-rigid, yet compliant outer surface 254. Further, the connector body 250 may be formed of conductive or non-conductive materials or a combination thereof. Manufacture of the connector body 250 may include casting, extruding, cutting, turning, drilling, knurling, injection molding, spraying, blow molding, component overmolding, combinations thereof, or other fabrication methods that may provide efficient production of the component.

Further embodiments of connector 200 may include a connector body member 90 formed of a conductive or non-conductive material. Such materials may include, but are not limited to conductive polymers, plastics, elastomeric mixtures, composite materials having conductive properties, soft metals, conductive rubber, rubber, and/or the like and/or any workable combination thereof. The connector body member 90 may comprise a substantially circinate torus or toroid structure, or other ring-like structure. For example, an embodiment of the connector body member 90 may be an O-ring disposed proximate the second end 252 of connector body 250 and the cavity 38 extending axially from the edge of first end 31 and partially defined and bounded by an outer internal wall 39 of coupling element 30 (see FIG. 4) such that the connector body O-ring 90 may make contact with and/or reside contiguous with the extended annular surface 256 of connector body 250 and outer internal wall 39 of coupling element 30 when operably attached to post 40 of connector 200. The connector body member 90 may facilitate an annular seal between the coupling element 30 and connector body 250 thereby providing a physical barrier to unwanted ingress of moisture and/or other environmental elements. Moreover, the connector body member 90 may facilitate further electrical coupling of the connector body 250 and coupling element 30 by extending therebetween an unbroken electrical circuit if connector body member 90 is conductive (i.e. formed of conductive materials). In addition, the connector body member 90 may further facilitate grounding of the connector 200, and attached coaxial cable 10 by extending the electrical connection between the connector body 250 and the coupling element 30. Furthermore, the connector body member 90 may effectuate a buffer preventing ingress of electromagnetic noise between the coupling element 30 and the connector body 250. It should be recognized by those skilled in the relevant art that the connector body member 90 may be manufactured by extruding, coating, molding, injecting, cutting, turning, elastomeric batch processing, vulcanizing, mixing, stamping, casting, and/or the like and/or any combination thereof in order to provide efficient production of the component.

Referring to FIGS. 1-1, a method of facilitating continuity through a coaxial cable connector 100 may include the steps of providing a post 40 having a first end 41, a second end 42, and a flange 45 proximate the second end 42, wherein the post 40 is configured to receive a center conductor 18 surrounded by a dielectric 16 of a coaxial cable 10, a connector body 50 attached to the post 40, and a coupling element 30 attached to the post 40, the coupling element 30 having a first end 31 and a second end 32, and disposing a biasing member 70 within a cavity 38 formed between the first end 31 of the coupling element 30 and the connector body 50 to bias the coupling element 30 against the post 40.

Furthermore, a method of facilitating continuity through a coaxial cable connector 200 may include the steps of providing a post 40 having a first end 41, a second end 42, and a flange 45 proximate the second end 42, wherein the post 40 is configured to receive a center conductor 18 surrounded by a dielectric 16 of a coaxial cable 10, a coupling element 30 attached to the post 40, the coupling element 30 having a first end 31 and a second end 32, and a connector body 250 having a first end 251, a second end 252, and an annular surface 256 proximate the second end of the connector body, and extending the annular surface 256 a radial distance to engage the coupling element 30, wherein the engagement between the extended annular surface 256 and the coupling element 30 biases the coupling element 30 against the post 40.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A coaxial cable connector grounding device comprising:
a biasing portion having a forward facing body surface relative to a forward direction toward an interface port when a coaxial cable connector engages the interface port;
wherein the forward facing body surface is configured to exert a biasing force against a rearward facing coupler surface of a coupler portion of the coaxial cable connector so as to biasingly maintain a ground path between a post portion of the coaxial cable connector and a coupler portion of the coaxial cable connector during operation of the coaxial cable connector, including when the coaxial cable connector is not fully tightened onto the interface port; and
wherein the biasing portion is configured to deflect in an axial direction based on a configuration of a groove portion of a body portion of the coaxial cable connector.

2. The coaxial cable connector grounding device of claim 1, wherein the coupler portion is configured to move between a first position, when the coupler portion is partially threaded on the interface port, and a second position, when the coupler portion is fully threaded on the interface port.

3. The coaxial cable connector grounding device of claim 1, wherein the rearward facing coupler surface comprises a radial contact surface.

4. The coaxial cable connector grounding device of claim 1, wherein the forward facing body surface of the biasing portion extends a radial distance to engage the rearward facing coupler surface of the coupler portion.

5. The coaxial cable connector grounding device of claim 1, wherein the biasing portion cooperates with the groove portion to permit a deflection necessary to bias the coupler portion against a flange of the post portion.

6. The coaxial cable connector grounding device of claim 1, wherein the biasing portion includes a resilient portion configured to flex between an un-deformed state and a deformed state.

7. The coaxial cable connector grounding device of claim 1, wherein the coupler portion is configured to threadingly engage the interface port and wherein the forward facing body surface is configured to bias the coupler portion forward when the coupler portion threadingly disengages the interface port.

8. The coaxial cable connector grounding device of claim 1, wherein the biasing force comprises a constantly applied spring force when the coupler portion is not fully tightened on the interface port.

9. The coaxial cable connector grounding device of claim 1, wherein the coupler portion includes an inward lip defining a forward facing coupler surface relative to a forward direction toward the interface port, wherein a rearward facing post surface is defined by an outwardly projecting flange of the post portion, and wherein the biasing portion of the body portion is configured to bias the forward facing coupler surface against the rearward facing post surface to biasingly prevent separation between the post and coupler portions and biasingly maintain a ground path between the post and coupler portions during operation of the connector.

10. A coaxial cable connector grounding device comprising:
a biasing portion having a forward facing surface relative to a forward direction toward an interface port when a coaxial cable connector engages the interface port;
wherein the forward facing surface is configured to exert a biasing force against a rearward facing surface of a first portion of the coaxial cable connector so as to biasingly maintain a ground path between a post portion of the coaxial cable connector and a second portion of the coaxial cable connector during operation of the coaxial cable connector, including when the coaxial cable connector is not fully tightened onto the interface port; and
wherein the biasing portion is configured to deflect in an axial direction based on a configuration of a groove portion of a third portion of the coaxial cable connector.

11. The coaxial cable connector grounding device of claim 10, wherein the first portion of the coaxial cable connector comprises a coupler portion.

12. The coaxial cable connector grounding device of claim 11, wherein the second portion of the coaxial cable connector comprises a post portion.

13. The coaxial cable connector grounding device of claim 12, wherein the third portion of the coaxial cable connector comprises a body portion.

14. The coaxial cable connector grounding device of claim 13, wherein the forward facing surface of the biasing portion comprises a forward facing body surface of the body portion.

15. The coaxial cable connector grounding device of claim 11, wherein the coupler portion is configured to move between a first position, when the coupler portion is partially threaded on the interface port, and a second position, when the coupler portion is fully threaded on the interface port.

16. The coaxial cable connector grounding device of claim 14, wherein the rearward facing surface of the coupler portion comprises a radial contact surface, and
wherein the forward facing body surface of the biasing portion extends a radial distance to engage the rearward facing surface of the first portion.

17. The coaxial cable connector grounding device of claim 14, wherein the coupler portion threadingly engages the interface port and wherein the forward facing body surface is configured to bias the coupler portion forward when the coupler portion threadingly disengages the interface port.

18. The coaxial cable connector grounding device of claim 11, wherein the biasing force comprises a constantly applied spring force when the coupler portion is not fully tightened on the interface port.

19. The coaxial cable connector grounding device of claim 14, wherein the coupler portion includes an inward lip defining a forward facing coupler surface relative to a forward direction toward the interface port, wherein a rearward facing post surface is defined by an outwardly projecting flange of the post portion, and wherein the biasing portion of the body portion is configured to bias the forward facing coupler surface against the rearward facing post surface to biasingly prevent separation between the post and coupler portions and biasingly maintain a ground path between the post and coupler portions during operation of the connector.

20. A connector grounding device for coaxial cable comprising:
a body portion configured to resiliently bias a contact portion of a coupling portion of a connector when the connector is assembled; and
wherein the body portion includes a deflection space portion configured to allow the resilient biasing by permitting a portion of the body portion to flexibly deflect along an axial direction and exert a biasing force against the contact portion of the coupling portion sufficient to axially move an inward lip of the coupling portion toward a flange of a post portion when the coupling portion axially moves between a first position and a second position so as to improve a ground path between the coupling portion and the post portion even when the coupling portion is not fully tightened on an interface port.

21. The connector grounding device of claim 20, wherein the post portion is configured to receive the coaxial cable.

22. The connector grounding device of claim 20, wherein the coupling portion is configured to be coupled to the interface port, engage the post portion, and axially move between the first position, where the post portion does not engage the interface port, and the second position, where the post portion engages the interface port, the second position being axially spaced from the first position.

23. The connector grounding device of claim 20, wherein the body portion is configured to engage the coaxial cable when the connector is in an assembled state.

24. The connector grounding device of claim 20, wherein the coupling portion is configured to move between a first position, when the coupling portion is partially threaded on the interface port, and a second position, when the coupling portion is fully threaded on the interface port.

25. The connector grounding device of claim 20, wherein the coupling portion includes a rearward facing surface that comprises a radial contact surface, and
wherein the biasing portion includes a forward facing body surface that extends a radial distance to engage the rearward facing surface of the first portion.

26. The connector grounding device of claim 25, wherein the coupling portion threadingly engages the interface port and wherein the forward facing body surface is configured to bias the coupling portion forward when the coupling portion threadingly disengages the interface port.

27. The connector grounding device of claim 20, wherein the biasing force comprises a constantly applied spring force when the coupling portion is not fully tightened on the interface port.

28. The connector grounding device of claim 20, wherein the coupling portion threadingly engages the interface port and wherein a forward facing body surface is configured to bias the coupling portion forward when the coupling portion threadingly disengages the interface port.

29. The connector grounding device of claim 20, wherein the coupling portion includes an inward lip defining a forward facing coupling surface relative to a forward direction toward the interface port, wherein a rearward facing post surface is defined by an outwardly projecting flange of the post portion, and wherein the biasing portion of the body portion is configured to bias the forward facing coupling surface against the rearward facing post surface to biasingly prevent separation between the post and coupling portions and biasingly maintain a ground path between the post and coupling portions during operation of the connector.

30. A connector grounding device for coaxial cable comprising:
a first portion configured to resiliently bias a contact portion of a second portion of a connector when the connector is assembled, the second portion being configured to be coupled to an interface port; and
wherein the first portion includes a deflection space portion configured to allow the resilient biasing by permitting a portion of the first portion to flexibly deflect along an axial direction and exert a biasing force against the contact portion of the second portion sufficient to axially move an inward lip of the second portion toward a flange of a third portion when the second portion axially moves between a first position and a second position so as to improve a ground path between the second portion and the third portion even when the second portion is not fully tightened on the interface port.

31. The connector grounding device of claim 30, wherein the first portion comprises a body portion, the second portion comprises a coupling portion, and the third portion comprises a post portion.

32. The connector grounding device of claim 31, wherein the post portion is configured to receive the coaxial cable.

33. The connector grounding device of claim 32, wherein the coupling portion is configured to be coupled to the interface port, engage the post portion, and axially move between the first position, where the post portion does not engage the interface port, and the second position, where the post portion engages the interface port, the second position being axially spaced from the first position.

34. The connector grounding device of claim 33, wherein the body portion is configured to engage the coaxial cable when the connector is in an assembled state.

35. The connector grounding device of claim 31, wherein the coupling portion is configured to move between a first position, when the coupling portion is partially threaded on the interface port, and a second position, when the coupling portion is fully threaded on the interface port.

36. The connector grounding device of claim 31, wherein the coupling portion includes a rearward facing surface comprising a radial contact surface, and
wherein the biasing portion includes a forward facing body surface that extends a radial distance to engage the rearward facing surface of the coupling portion.

37. The connector grounding device of claim 36, wherein the coupling portion threadingly engages the interface port and wherein the forward facing body surface is configured to bias the coupling portion forward when the coupling portion threadingly disengages the interface port.

38. The connector grounding device of claim 31, wherein the biasing force comprises a constantly applied spring force when the coupling portion is not fully tightened on the interface port.

39. The connector grounding device of claim 31, wherein the coupling portion includes an inward lip defining a forward facing coupling surface relative to a forward direction toward the interface port, wherein a rearward facing post surface is defined by an outwardly projecting flange of the post portion, and wherein the biasing portion of the body portion is configured to bias the forward facing coupling surface against the rearward facing post surface to biasingly prevent separation between the post and coupling portions and biasingly maintain a ground path between the post and coupling portions during operation of the connector.

40. A connector grounding device for coaxial cable comprising:
biasing means for resiliently biasing a contact portion of a first portion of a connector when the connector is assembled, the first portion being configured to be coupled to an interface port; and
wherein the biasing means includes a deflection space portion configured to allow the resilient biasing by permitting a portion of the biasing means to flexibly deflect along an axial direction and exert a biasing force against the contact portion of the first portion sufficient to axially move an inward lip of the first portion toward a flange of a second portion when the first portion axially moves between a first position and a second position so as to improve a ground path between the first portion and the second portion even when the first portion is not fully tightened on the interface port.

41. The connector grounding device of claim 40, wherein the biasing means comprises a body portion, the first portion comprises a coupling portion, and the second portion comprises a post portion.

42. The connector grounding device of claim 41, wherein the post portion is configured to receive the coaxial cable.

43. The connector grounding device of claim 42, wherein the coupling portion is configured to be coupled to the interface port, engage the post portion, and axially move between the first position, where the post portion does not engage the interface port, and the second position, where the post portion engages the interface port, the second position being axially spaced from the first position.

44. The connector grounding device of claim 43, wherein the body portion is configured to engage the coaxial cable when the connector is in an assembled state.

45. The connector grounding device of claim 41, wherein the coupling portion is configured to move between a first position, when the coupling portion is partially threaded on the interface port, and a second position, when the coupling portion is fully threaded on the interface port.

46. The connector grounding device of claim 41, wherein the coupling portion includes a rearward facing surface that comprises a radial contact surface, and
wherein biasing means includes a forward facing body surface that extends a radial distance to engage the rearward facing surface of the coupling portion.

47. The connector grounding device of claim 41, wherein the biasing force comprises a constantly applied spring force when the coupling portion is not fully tightened on the interface port.

48. The connector grounding device of claim 46, wherein the coupling portion threadingly engages the interface port and wherein the forward facing body surface is configured to bias the coupling portion forward when the coupling portion threadingly disengages the interface port.

49. The connector grounding device of claim 41, wherein the coupling portion includes an inward lip defining a forward facing coupling surface relative to a forward direction toward the interface port, wherein a rearward facing post surface is defined by an outwardly projecting flange of the post portion, and wherein the biasing portion of the body portion is configured to bias the forward facing coupling surface against the rearward facing post surface to biasingly prevent separation between the post and coupling portions and biasingly maintain a ground path between the post and coupling portions during operation of the connector.
